(19) United States
(12) Patent Application Publication
(10) Pub. No.: US 2003/0219584 A1
(43) Pub. Date: Nov. 27, 2003

(54) Sheet, thermoformed article and laminate structure

(75) Inventors: Kenichi Higashi, Sodegaura-shi (JP); Koichi Yanase, Ichihara-shi (JP); Takashi Fujimoto, Sodegaura-shi (JP)

Correspondence Address: Kendrew H. Colton, Fitch, Even, Tabin & Flannery, Suite 401L, 1801 K Street, N.W., Washington, DC, 20006-1201, US

(73) Assignee: Sumitomo Chemical Company, Limited, Osaka (JP)

(21) Appl. No.: 10/377,120

(22) Filed: Mar. 3, 2003

(30) Foreign Application Priority Data
Mar. 5, 2002 (JP) 2002-058616
Mar. 27, 2002 (JP) 2002-088570

(51) Int. Cl. B32B 3/26

(52) U.S. Cl. 428/304.4

(57) ABSTRACT

Disclosed are a sheet which has a resin layer comprising a polyolefin resin with a degree of crystallinity of at least 45% wherein the resin layer has a total haze of up to 10% and wherein at least one surface of the sheet is the resin layer, a thermoformed article obtained by thermoforming the sheet, and a laminate structure comprising the sheet or thermoformed article and a substrate made of a thermoplastic resin, the substrate being laminated on the sheet or thermoformed article.

### BACKGROUND OF THE INVENTION

1. Field of the Invention

The present invention relates to sheets having a surface layer made of a polyolefin resin, thermoformed articles and laminate structures.

2. Description of the Related Art

In the production of a formed article of a thermoplastic resin used in the field of automobiles or in the field of household electrical appliances, particularly in the production of injection moldings, as an approach for improving the surface appearance or scratch resistance of a molding, known is a method comprising injecting a molten thermoplastic resin into a mold cavity in which a decoration sheet, e.g. a transparent resin sheet or a multilayer resin sheet having a transparent surface layer has been set, thereby laminating the molten resin and the sheet. In many cases, an injection molding has a three-dimensional configuration. However, it is difficult to produce an injection molding which has a three-dimensional configuration and which also has a decoration sheet laminated on its surface, by setting in a mold cavity the decoration sheet as received. Therefore, in many cases, the decoration sheet is shaped into a desired configuration in advance by thermoforming, e.g. vacuum forming, thereby producing a thermoformed article and subsequently the thermoformed article is set in a mold cavity and then a molten thermoplastic resin is injected into the cavity.

As the transparent sheet or the transparent layer in the multilayer resin sheet mentioned above, polymethyl methacrylate has often been employed for achieving a highly glossy appearance and a high scratch resistance simultaneously. However, use of polyolefin resins, particularly propylene polymers, which are less expensive than polymethyl methacrylate and superior in recyclability, have recently been desired.

### SUMMARY OF THE INVENTION

However, in sheets made of conventional polyolefin resins, transparency and scratch resistance are not well-balanced. Under such circumstances, the object of the present invention is to provide a sheet, thermoformed article and laminate structure having well-balanced transparency and scratch resistance.

In a first aspect, the present invention relates to a sheet which has a resin layer comprising a polyolefin resin with a degree of crystallinity of at least 45% wherein the resin layer has a total haze of up to 10% and wherein at least one surface of the sheet is the resin layer.

In a second aspect, the present invention relates to a thermoformed article which is obtained by thermoforming the sheet.

In a third aspect, the present invention relates to a laminate structure comprising the sheet or thermoformed article and a substrate of a thermoplastic resin laminated on the sheet or thermoformed article.

In a fourth aspect, the present invention relates to applications of the laminate structure.

It is noted that films and sheets are generally distinguished in terms of thickness, but in the present invention they are collectively called sheets.

### BRIEF DESCRIPTION OF THE DRAWINGS

In the drawings,

FIG. 1 shows a perspective view of the lamination moldings produced in Example land Comparative Example 1, wherein numeral 1 indicates a sheet and numeral 2 indicates a substrate, and

FIG. 2 shows a perspective view of a thermoforming mold used in Examples 2, 3 and Comparative Example 2, 3.

### DESCRIPTION OF PREFERRED EMBODIMENTS

The sheet of the present invention has a resin layer whose degree of crystallinity is 45% or more. The degree of crystallinity is determined by DSC measurement. A sheet is measured for the quantity of its heat of fusion (ΔHm) when it is heated at a rate of 10° C./min. The resulting value is divided by a value of ΔHm obtained in the case of 100% crystal, thereby resulting in a degree of crystallinity. As the value of ΔHm obtained in the case of 100% crystal, used is a value disclosed in literature such as “Kobunshi No Bussei (1) (Physical Properties of Macromolecules, No. 1), Kobunshi Jikkengaku 8 (Experiments of Macromolecules, Vol. 8)” (published by Kyoritsu Shuppan Kabushiki Kaisha). When two or more values are written side by side, the average thereof is used. The upper limit of the degree of crystallinity is not particularly limited, but is usually up to 70%. The degree of crystallinity is preferably from 47% to 65%.

The sheet of the present invention preferably has a surface with a pencil hardness of H or harder. The pencil hardness referred to in the present invention is measured by a pencil scratch test provided in JIS K5400.

The resin layer preferably has a total haze of up to than 10%, and more preferably up to than 5%. A small total haze is preferred because a thermoformed article obtained by thermoforming the sheet so that the resin layer forms a surface of the article or a laminate structure obtained by lamination molding so that a layer resulting from the resin layer forms a surface of the laminate structure will have a highly glossy appearance. When the sheet contains a design layer, a superior deep feeling of the design is achieved.

When the sheet of the present invention has one or more layers other than the aforementioned resin layer, the total haze of the resin layer is estimated by preparing a sheet under conditions the same as those under which the sheet of the present invention was produced except forming no layers other than the resin layer. Alternatively, the total haze is determined by peeling off the resin layer from the multilayer sheet and measuring the total haze of the resin layer peeled.

The resin layer is made of a polyolefin resin. The polyolefin resin used herein is a thermoplastic resin obtained by addition polymerization of olefin and examples thereof include propylene polymers, ethylene polymers and 1-butene polymers. Propylene polymers are preferred. The propylene polymers used herein are polymers obtained by polymerizing propylene and examples thereof include propylene homopolymers, copolymers made up of propylene and α-olefin having from 2 to 12 carbon atoms other than propylene in an amount such that the degree of crystallinity is not lost, and mixtures of multiple resins chosen from them. Examples of the α-olefin include ethylene, 1-butene, 4-methyl-1-pentene, 1-hexene and 1-octene. In the case of copolymers, the content of repeating units derived from monomers other than propylene is preferably up to 10% by weight for ethylene and up to 30% by weight for α-olefins having from 4 to 12 carbon atoms. More preferable the propylene polymers are propylene homopolymers. Still more preferable are propylene homopolymers having an isotactic pentad fraction of 0.95 or more. Particularly preferable are propylene homopolymers having an isotactic pentad fraction of 0.97 or more.

The method for producing the propylene polymers is not particularly restricted and may be gas phase polymerization, solvent polymerization and the like. Gas phase polymerization is particularly preferable. As a catalyst used in the polymerizations, various known catalysts can be used. Preferred are multiple site catalysts obtained by use of a solid catalyst component containing a titanium atom, a magnesium atom and a halogen atom or single site catalyst obtained by use of a metallocene complex or the like.

The sheet of the present invention may be a single layer sheet made up only of the above-mentioned resin layer and also may be a multilayer sheet containing at least one resin layer mentioned above. When the sheet of the present invention is a multilayer sheet, it is preferable that the sheet have the above-mentioned resin layer as a surface of the sheet. In such an event, the resin layer may form both surfaces of the multilayer sheet. However, taking a use mode of a sheet where the sheet is thermoformed and then attached to a substrate made of a thermoplastic resin into consideration, it is preferable that the resin layer be present so as to form only one surface of the sheet.

When the sheet of the present invention is a single layer sheet, the sheet of the present invention can be produced by:

preparing a mother sheet by a production method comprising a step of melt kneading the above-mentioned resin in an extruder, a step of extruding the melt through a die lip, and a step of forming a film by cooling and solidifying the extrudate on cooling rolls, and

subjecting the mother sheet to heat treatment.

As a machine used for preparing the mother sheet, a known T-die processing machine can be used. The cooling rolls used herein are rolls such that both surfaces of the molten resin are pressed between the rolls to be cooled. The set temperature of the cooling rolls is usually from 30° C. to 100° C., and preferably from 35° C. to 80° C.

When a sheet made of a polyolefin resin is thermoformed, unfavorable fine asperities often appear in a surface of the sheet. However, when, in the production of a mother sheet, the temperature of a melt which is extruded through a die lip is set higher than a temperature usually employed and FLEX-ROLL available from SHI Modern Machinery, Ltd. (old name: CBC Tech Co.), for example, is used as cooling rolls, the unfavorable asperities are reduced or eliminated. The FLEX-ROLL is a thin sheet forming roll comprising a metallic elastic external cylinder and shafts which close both ends of the metallic elastic external cylinder. For more details about the FLEX-ROLL, see a specification of W097/28950, for example. A preferable temperature of the melt of a resin at the time when the melt is extruded from a die lip varies depending upon the resin used and can not be generalized. However, when a propylene homopolymer resin is used, the temperature of the melt thereof is usually within the range of from 210° C. to 280° C., preferably within the range of from 220° C. to 270° C.

As the method for the above-mentioned heat treatment, any method can be employed. For example, methods using a heat roll, a heating oven, a far infrared heater or hot air blowing are mentioned. Preferred are the methods using a heat roll or hot air blowing. The conditions under which the heat treatment is conducted vary depending upon the composition of the resin which forms the sheet. For example, when a propylene polymer is used, the heat treatment is carried out by adjusting the surface temperature of the sheet to 130-166° C., preferably 135-165° C. through adjustment of the temperature of the heating medium such as a heat roll, for a treatment time of from 1 second to 300 seconds, preferably from 1 second to 120 seconds. The “treatment time” used herein is a heating time after the surface temperature of the sheet reached the above-mentioned range. When a heat roll is used, the treatment time is the sum of the times when the sheet is in contact with the heat roll after the surface temperature of the sheet reached the above-mentioned range. When a heating oven is used, the time during which the sheet held in the heating oven after the surface temperature of the sheet reached the above-mentioned range. The surface temperature of the sheet and the treatment time within the ranges mentioned previously are favorable because the degree of crystallinity of the resin is well increased and the transparency is not lost. The heat treatment may be carried out continuously. An alternative method is a method in which a sheet is cut into cut sheets of optional sizes, which are then treated sheet by sheet. It is preferable to conduct the heat treatment step in such a manner that the elongation of the sheet is prevented as much as possible.

When the sheet of the present invention is a multilayer sheet, the sheet of the present invention can be produced by:

preparing first a mother multilayer sheet by a method where the above-mentioned resin and other resin or resins are coextruded, a method in which to one surface of a film previously formed from the above-mentioned resin other resin or resins are attached by pressure, or a method in which two or more sheets previously prepared are laminated one after another using an adhesive or the like, and

then heat treating the resulting mother multilayer sheet. An alternative possible method is a method in which sheets previously heat treated are laminated in the above-mentioned method.

The machine for producing the mother sheet is exemplified by known coextrusion T-die processing machines and known extrusion lamination processing machines.

The sheet of the present invention is suitably used as a sheet for thermoforming. That is, the sheet can be shaped by thermoforming.

The sheet of the present invention is thermoformed, resulting in a thermoformed article of the present invention. The sheet or thermoformed article of the present invention is suitably used as a decoration sheet for improving the appearance of a substrate made of a thermoplastic resin through the lamination thereof onto the substrate. For example, when a sheet consisting of the above-mentioned resin layer or a thermoformed article made from the sheet is laminated to a colored substrate, the color of the substrate will have a deep feeling. In addition, when a sheet comprising a highly transparent resin layer having thereon a design layer having a design such as color or print or a thermoformed article made from the sheet is laminated to a substrate, the substrate will have a superior surface appearance, that is, the substrate is decorated. At the same time the design will have a deep feeling.

The sheet of the present invention preferably has the aforementioned resin layer and a design layer for achieving an efficient decoration of a substrate. Such a sheet is exemplified by a laminate sheet having two layers, namely, a transparent layer and a print or colored layer, a laminate sheet having a transparent layer, a print layer and a colored layer, and a laminate sheet having a transparent layer and a print layer and/or a colored layer and a backing layer.

The laminate structure of the present invention is a laminate structure resulting from lamination of the above-mentioned sheet or thermoformed article and a substrate made of a thermoplastic resin. Here, as the thermoplastic resin for forming the substrate, any thermoplastic resin may be employed, but those used in the fields of automobiles or household electrical appliances are preferably employed. Crystalline polyolefin polymer resin is more preferable.

By the crystalline olefin polymer resin is meant a resin comprising a crystalline olefin polymer. Examples of the resin include propylene polymers, ethylene polymers and 1-butene polymers, preferably propylene polymers. The propylene polymers used herein are polymers obtained by polymerizing propylene and specific examples thereof include propylene homopolymer and copolymers obtained by copolymerizing propylene and other comonomer(s) (e.g. ethylene and 1-butene). Such copolymers may be random copolymers or block copolymers. The crystalline olefin polymer resins used in the present invention are preferably propylene homopolymers, more preferably propylene homopolymers having an isotactic pentad fraction of not less than 0.95, and particularly preferably propylene homopolymers having an isotactic pentad fraction of not less than 0.97.

The thermoplastic resin for forming the substrate is preferably a resin capable of adhering easily to the thermoformed article, and more preferably a resin capable of adhering by welding to the thermoformed article. From the viewpoint of adhesiveness between the thermoformed article and the substrate, the resin which forms a surface of the thermoformed article, the surface being to be adhered to the substrate, and the resin of the substrate are preferably the same or similar resins (for example, both are propylene polymers).

The production method of the laminate structure of the present invention may be a method comprising the steps (1) through (4) shown below:

(1) A step of heating and softening the sheet of the present invention;

(2) A step of thermoforming the softened sheet using a mold for thermoforming to obtain a thermoformed article;

(3) A step of setting the thermoformed article in a cavity of a mold for molding; and

(4) A step of injecting a molten thermoplastic resin for forming a substrate into the mold cavity in which the thermoformed article has been set, thereby obtaining a laminate structure in which the resin injected (that is, a substrate) and the thermoformed article have been laminated together.

Examples of the thermoforming method relating to steps (1) and (2) include vacuum forming, air pressure forming, vacuum-pressure forming, etc. In these steps, the temperature to which the sheet is heated is usually not lower than (the melting point of the sheet −20° C.) an not higher than (the melting point of the sheet +10° C.), preferably not lower than (the melting point of the sheet −15° C.) an not higher than (the melting point of the sheet +5° C.), and more preferably not lower than (the melting point of the sheet −15° C.) an not higher than the melting point of the sheet. It is noted that the “melting point of the sheet” used herein indicates the highest melting point of the melting points of the resins constituting the sheet.

As the mold for thermoforming, molds which are made, for example, of metal, resin, wood or paper can be employed. Preferred is a mold made of metal. The thermoforming mold preferably has a smooth surface. With regard to the surface roughness of the thermoforming mold, the center-line mean roughness (Ra) measured in accordance with JIS B0601 is preferably up to 0.10 μm, more preferably up to 0.08 μm, and particularly preferably up to 0.06 μm.

Moreover, it is preferable to cool the sheet rapidly after shaping the sheet by contacting it to the thermoforming mold. For this purpose, it is desirable to hold the temperature of the thermoforming mold within the range of from 10 to 50° C., more desirably from 20 to 30° C.

Moreover, it is preferable to cool the shaped sheet rapidly by bringing it into contact with a fluid of a lower temperature. For example, it is recommended to set the temperature of the fluid to 10-20° C. The fluid is exemplified by air and water.

Examples of the molding method relating to step (4) include injection molding, injection compression molding and injection press molding. The temperature of the resin injected in this step is usually not lower than the melting point of the resin, and preferably not lower than 200° C. The temperature of the mold in this step is usually from 20 to 60° C., and preferably from 30 to 40° C. The surface of the mold is preferably smooth. The surface roughness (Ra) is preferably 0.1 μm or less, more preferably 0.08 μm or less, and still more preferably 0.06 μm or less.

It is possible to employ an apparatus and technique, such as thermoject technique, which can perform steps (1) through (4) in one step.

When the sheet of the present invention is a single layer sheet or a multilayer sheet both surfaces of which are each formed of the aforementioned resin layer, the molten resin may be injected to any side of the sheet in the above-mentioned step (4). On the other hand, when the sheet of the present invention is a multilayer sheet just one side of which is formed of the aforementioned resin layer, the molten resin is, in step (4), injected to the side opposite to the surface of the sheet formed of resin layer.

In the laminate structure of the present invention, the substrate made of a thermoplastic resin may also be a foamed substrate.

The foamed substrate made of a thermoplastic resin can be formed by foam molding of a thermoplastic resin containing a foaming agent. The laminate structure having the foamed substrate can be produced, for example, by a method the same as that comprising steps (1)-(4) mentioned above except injecting a thermoplastic resin containing a foaming agent in step (4).

The foaming agent used in the present invention is not particularly restricted as long as it is a foaming agent that is used for injection foam molding of a thermoplastic resin. Examples thereof include organic chemical foaming agents typified by ADCA type chemical foaming agents; and inorganic chemical foaming agents typified by sodium bicarbonate and citric acid. The latter is preferred from the viewpoint of prevention of mold pollution.

Since those chemical foaming agents generate a gas in an amount which varies depending upon the resin temperature at the time of molding, it is difficult to provide a general amount of those agents to be used. They may be added in an amount suited to the expansion ratio of a final product.

The laminate structure of the present invention, especially that is obtained by laminating a multilayer thermoformed article made from a decorated sheet such as a colored sheet, a grain-patterned sheet, a metallic sheet, and a carbon tone sheet with a substrate is suitably used as an automotive component (interior component or exterior component). It is also suitable for applications including components of household appliances, parts of sundries, signboards, etc.

The various kinds of resins used in the present invention may be used in combination with various kinds of additives, as needed. Examples of the additives include antioxidants, stabilizers, antistatic agents, nucleating agents, adhesives and antifogging agents.

The thickness of the sheet of the present invention is usually from 5 to 800 μm, and preferably from 50 to 500 μm.

### EXAMPLES

The present invention will be further described based on examples below. However, the invention is not restricted to the examples.

The values of physical properties were determined by the methods shown below.

1. Degree of Crystallinity

The degree of crystallinity was measured within the range of from 20° C. to 260° C. at a heating rate of 10° C./min using a DSC manufactured by Seiko Instruments Inc. From a melting peak of a crystalline component observed, the quantity of heat of crystal fusion ΔHm was determined. The degree of crystallinity (%) was obtained by dividing the ΔHm by a value of ΔHm in the case of 100% crystal. As the ΔHm of 100% crystal of polypropylene, used was a value of 207 mJ/mg, which is disclosed in “Kobunshi No Bussei (1) (Physical Properties of Macromolecules, No. 1), Kobunshi Jikkengaku 8 (Experiments of Macromolecules, Vol. 8),” page 851 (published by Kyoritsu Shuppan Kabushiki Kaisha).

2. Haze

Haze was measured in accordance with JIS K7105.

3. Pencil Hardness

The pencil hardness was measured in accordance with the pencil scratch test provided in JIS K5400. The evaluation was begun with a test using a pencil with a hardness of 6B and the hardness was then gradually increased as 5B, 4B, . . . The hardness of a sample was indicated by a pencil hardness detected when the surface was damaged first.

4. Surface Appearance

The appearance of laminate structures were visually observed. The degree of silver streaks was evaluated visually.

5. Gloss

Measurement of a 60° specular gloss was carried out in accordance with the method of testing glossiness indicated in JIS K7105.

6. Weight of Product

The weight of a molded article was determined using a platform scale.

### Comparative Example 1

(Sheet Formation)

A propylene polymer comprising 100 parts by weight of a propylene homopolymer and 0.3 part by weight of a nucleating agent (sodium 2,2-methylenebis(4,6-di-tert-butylphenyl) available as Adeca Stab NA-21 available from Asahi Denka Co., Ltd.) was processed with a T-die film forming machine (die width 600 mm) under conditions: a cylinder temperature of 239° C., an extrusion rate of 16 Kg/hr, a take-up rate of 5.4 m/min, a temperature of an emboss roll (mirror surface) of 20° C., and a temperature of a FLEX-ROLL (manufactured by CBC Tech Co.) of 20° C., resulting in a sheet having a thickness of 0.1 mm, a degree of crystallinity of 42% and a total haze of 3.5%.

The propylene polymer had an MFR of 8.0 g/10 min and an isotactic pentad fraction of 0.97.

(Lamination Molding)

Lamination molding was carried out by setting the resulting sheet inside a mold and subsequently injecting a molten resin for forming a substrate into the mold. The lamination molded article obtained was measured for its pencil hardness.

The evaluation results are shown in Table 1. Other conditions used in the lamination molding are as follows:

Injection molding machine: Injection molding machine FS160S25ASEN manufactured by Nissei Plastic Industrial Co., Ltd.

Molding temperature: 230° C.

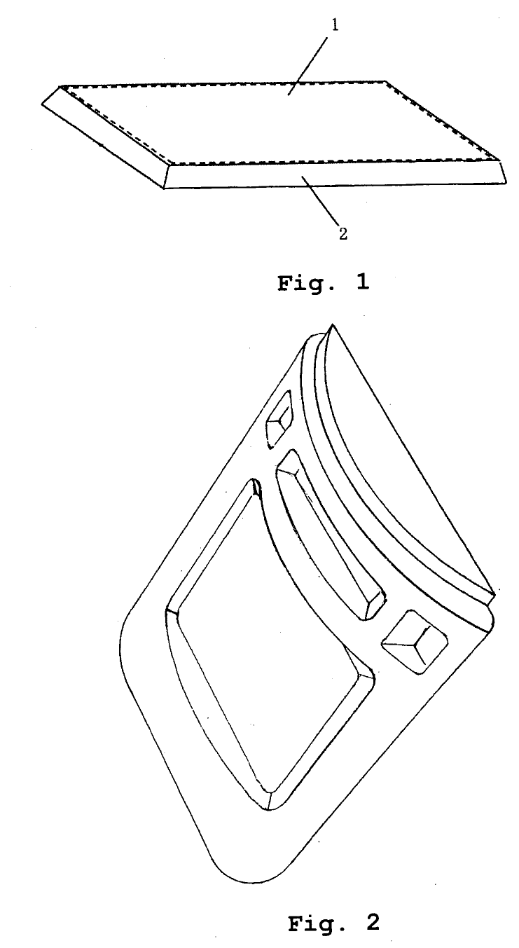

Mold: Outer dimensions of molded article=150 mm×300 mm×3 mm, fan gate. See FIG. 1 with respect to the shape.

Mold temperature: 30° C.

Resin for forming substrate: Composition described in Example 1 of JP, 11-29690,A. MFR=30 g/10 min.

### Example 1

A sheet obtained in the same manner as Comparative Example 1(1) was held in a 140° C. oven for 2 minutes, resulting in a sheet having a thickness of 0.1 mm, a degree of crystallinity of 50% and a total haze of 2.7%. During the treatment in the oven, the surface temperature of the sheet was measured with a thermocouple. It took one minute for the surface temperature to arrive at 140° C. After the arrival at that temperature, heating was continued for additional one minute.

TABLE 1

| | | | Comparative |
|---|---|---|---|
| | | Example 1 | Example 1 |
| Evaluation | Degree of | 50 | 42 |
| of | Crystallinity (%) | | |
| Sheet | Haze (%) | 2.7 | 3.5 |
| Evaluation of | Pencil | H | HB |
| Lamination Molding | Hardness | | |

### Comparative Example 2

(1) Thermoforming

A sheet obtained in the same manner as Comparative Example 1 was heated under conditions: far infrared heater temperature of 400° C., a distance between the heater and the sheet of 135 mm, and a heating time of 30 seconds. Subsequently, the sheet was subjected to thermoforming by contacting it to a surface (Ra=0.06 μm, mold temperature 30° C.) of a thermoforming mold having a-configuration shown in FIG. 2.

(2) Lamination Molding

The resulting thermoformed article was set in a mold for injection molding, the mold matching the configuration shown in FIG. 2. Subsequently, lamination molding the same as that of Comparative Example 1 (2) was carried out and evaluation were conducted. The results are shown in Table 2.

### Example 2

A sheet obtained by heat treating in the same manner as Example 1 was thermoformed under conditions the same as those used in Comparative Example 2(1).

TABLE 2

| | | | Comparative |
|---|---|---|---|
| | | Example 2 | Example 2 |
| Evaluation | Degree of | 52 | 43 |
| of | Crystallinity (%) | | |
| Thermoformed | Haze (%) | 2.4 | 3.0 |
| Article | | | |
| Evaluation of | Pencil | H | HB |
| Lamination Molding | Hardness | | |

### Example 3

(1) Production of Sheet

In the same manner as Comparative Example 1, obtained was a sheet having a thickness of 0.1 mm, a degree of crystallinity of 42% and a total haze of 3.5%. The sheet was heat treated in the same manner as Example 1, resulting in a sheet having a thickness of 0.1 mm, a degree of crystallinity of 50% and a total haze of 2.7%.

The propylene polymer used in the preparation of the sheet had an MFR of 8.0 g/10 min and an isotactic pentad fraction of 0.97.

(2) Thermoforming and Lamination Molding

The resulting sheet was heated and softened with a far infrared heater so that the surface temperature reached 153° C. The softened sheet was brought into contact with a surface (surface roughness Ra=0.06 μm, mold temperature=30° C.) of a thermoforming mold shown in FIG. 1, thereby being thermoformed. The resulting thermoformed article was set in a mold for injection molding and then lamination molding was carried out in the following manner.

As a thermoplastic resin for forming a substrate, used was a propylene-ethylene block copolymer (Sumitomo Noblen AZ161C manufactured by Sumitomo Chemical Co., Ltd., MFR=30 g/10 min). 3 Parts by weight of an inorganic chemical foaming agent(MB3062 manufactured by SANKYO Chemical Co., Ltd.) as a foaming agent master batch was used for 100 parts by weight of the thermoplastic resin for forming a substrate. 3 Parts by weight of Black SPEM-8H102HCAN manufactured by SUMIKA COLOR CO. LTD. was used for 100 parts by weight of the thermoplastic resin for forming a substrate. Using these materials, an injection molded article having a configuration shown in FIG. 1 was obtained by use of FS160S25ASEN (manufactured by NISSEI PLASTIC INDUSTRIAL CO., LTD.; using a shut-off nozzle), which is an injection molding machine. The results of the evaluation of the product are shown in Table 3.

### Comparative Example 3

Injection foam molding was carried out under conditions the same as those used in Example 3(2) except using no thermoformed article. The results of the evaluation of the product are shown in Table 3.

TABLE 3

| | | | Comparative |
|---|---|---|---|
| | | Example 3 | Example 3 |
| Surface | Haze (%) | 2.7 | No Surface Layer |
| Layer | Pencil Hardness | H | |
| Evaluation | Pencil Hardness | H | 6B |
| of | 60° Gloss (%) | 84 | 32 |
| Lamination | Silver Streaks | Slight | Heavy |
| Structure | Product Weight | 115 | 115 |

According to the present invention, a sheet, a thermoformed article and a laminate structure which are superior in transparency and scratch resistance are provided. In addition, even when a laminate structure having a foamed substrate is produced by injection foam molding, generation of silver streaks can be controlled and, as a result, an injection foam molding having a good appearance can be obtained.

What is claimed is:

1. A sheet which has a resin layer comprising a polyolefin resin with a degree of crystallinity of at least 45% wherein the resin layer has a total haze of up to 10% and wherein at least one surface of the sheet is the resin layer.

2. The sheet according to claim 1 wherein the sheet is a single layer sheet consisting of the resin layer.

3. The sheet according to claim 1 wherein the sheet is a multilayer sheet comprising the resin layer and at least one layer other than the resin layer wherein one surface of the sheet is the resin layer.

4. The sheet according to claim 3 wherein the at least one layer contains a design layer which is laminated on the resin layer.

5. A thermoformed article which is obtained by thermoforming the sheet according to any one of claims 1 to 4.

6. A laminate structure comprising the sheet according to any one of claims 1 to 4 or the thermoformed article according to claim 5 and a substrate made of a thermoplastic resin, the substrate being laminated on the sheet or thermoformed article.

7. The laminate structure according to claim 6 wherein the thermoplastic resin is a crystalline olefin polymer.

8. The laminate structure according to claim 6 wherein the substrate made of a thermoplastic resin is a foamed substrate.

9. An automotive component comprising the laminate structure according to any one of claims 6 to 8.
